(19) United States
(12) Patent Application Publication
(10) Pub. No.: US 2016/0250911 A1
(43) Pub. Date: Sep. 1, 2016

(54) DEFLECTOR FOR SUNROOF APPARATUS

(71) Applicants: NISSAN MOTOR CO., LTD., Yokohama-shi, Kanagawa (JP); INDIAN INSTITUTE OF TECHNOLOGY MADRAS, Chennai (IN)

(72) Inventors: Mitsuru Satou, Kanagawa (JP); Kazuya Asao, Kanagawa (JP); Hirotaka Tomita, Kanagawa (JP); Babu Viswanathan, Chennai (IN)

(21) Appl. No.: 15/029,101

(22) PCT Filed: Oct. 16, 2014
(86) PCT No.: PCT/JP2014/005264

§ 371 Date: Apr. 13, 2016

(30) Foreign Application Priority Data
Oct. 30, 2013 (IN) 1233/KOL/2013

(51) Int. Cl. B60J 7/22

(52) U.S. Cl. CPC B60J 7/226

(57) ABSTRACT

Provided is a deflector extending along the front edge of an opening provided in the roof of a vehicle. The deflector includes: multiple recessed portions each being formed to be recessed away from the front, and multiple projected portions each being formed to be projected further toward the front than the recessed portions. The recessed portions and the projected portions are arranged at the front surface of the deflector alternately in the extending direction of the deflector.

### TECHNICAL FIELD

The present invention relates to a deflector for a sunroof apparatus.

### BACKGROUND ART

It has been known that when a vehicle travels in a certain speed range with its sunroof opening or the like open, an aerodynamic noise of a large sound level called a wind throb is generated. This wind throb is made of low-frequency (about 5 to 50 [Hz]) pulsating sounds and considered to be generated due to a combination of periodic vortex shedding which occurs at the sunroof opening and Helmholtz resonance in which the cabin space acts as a resonance box.

Japanese Patent Application Publication No. 2004-168241 discloses a deflector for a sunroof apparatus configured such that recesses and projections are provided along the upper edge of a deflector blade to disturb the airflow over the sunroof opening and thereby reduce a wind throb.

### SUMMARY OF INVENTION

### Technical Problem

However, in the case of the above deflector, part of the airflow passing through the recesses may enter the cabin space through the sunroof opening that is open. Thus, the wind throb cannot be reduced sufficiently.

An object of the present invention is to provide a deflector for a sunroof apparatus capable of sufficiently reducing a wind throb.

### Solution to Problem

A first aspect of the present invention provides a deflector extending along a front edge of an opening provided in a roof of a vehicle. The deflector includes: multiple recessed portions each being formed to be recessed away from a front, and multiple projected portions each being formed to be projected further toward the front than the recessed portions. The recessed portions and the projected portions are arranged at a front surface of the deflector alternately in an extending direction of the deflector.

A second aspect of the present invention provides a deflector extending along a front edge of an opening provided in a roof of a vehicle. The deflector includes: multiple projections formed intermittently along the front edge of the opening, each of the projections being formed to be projected upward; a recess formed between the multiple projections; and a vertical wall arranged to stand behind the recess.

### BRIEF DESCRIPTION OF DRAWINGS

FIG. 1 is a perspective view showing a main part of a sunroof apparatus employing a deflector blade according an embodiment of the present invention.

FIG. 2 is a cross-sectional view taken along line II-II in FIG. 1.

FIG. 3 is an enlarged perspective view of the deflector blade in FIG. 1.

FIG. 4 is cross-sectional views of the deflector blade in FIG. 1; FIG. 4(a) shows a cross section of a recessed portion while FIG. 4(b) shows a cross section of a projected portion.

FIG. 5 is a partially cross-sectional perspective view for describing the configuration of the deflector blade in FIG. 1 from a different point of view.

FIG. 6 is a front view of the deflector blade in FIG. 1.

FIG. 7 is a view showing an operation of the deflector blade in FIG. 1.

FIG. 8 is a graph showing a wind-throb reducing effect of the deflector blade in FIG. 1.

FIG. 9 is a graph showing a wind-noise reducing effect of the deflector blade in FIG. 1.

FIG. 10 is cross-sectional views showing modifications of the deflector blade in FIG. 1.

### DESCRIPTION OF EMBODIMENTS

Hereinbelow, embodiments of the present invention will be described with reference to the drawings. Note that in the description of the drawings, the same components are denoted by the same reference numeral, and overlapping description thereof is omitted. Moreover, the proportional ratios in the drawings may be exaggerated for the sake of explanation and differ from the actual ratios.

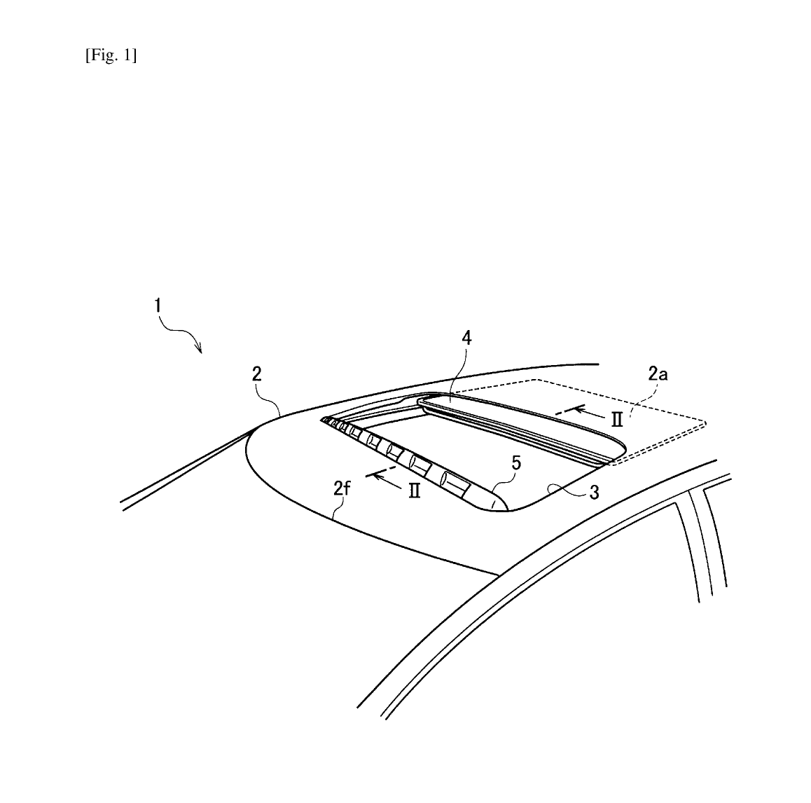

FIG. 1 is a sunroof apparatus employing a deflector blade (deflector) according to an embodiment of the present invention. In a roof 2 of a vehicle 1, a substantially rectangular sunroof opening (hereinafter, simply referred to as “opening” as well) 3 is provided. The opening 3 can be opened and closed by a lid 4 having an outer shape corresponding to the shape of the opening 3 and made of a glass plate, for example.

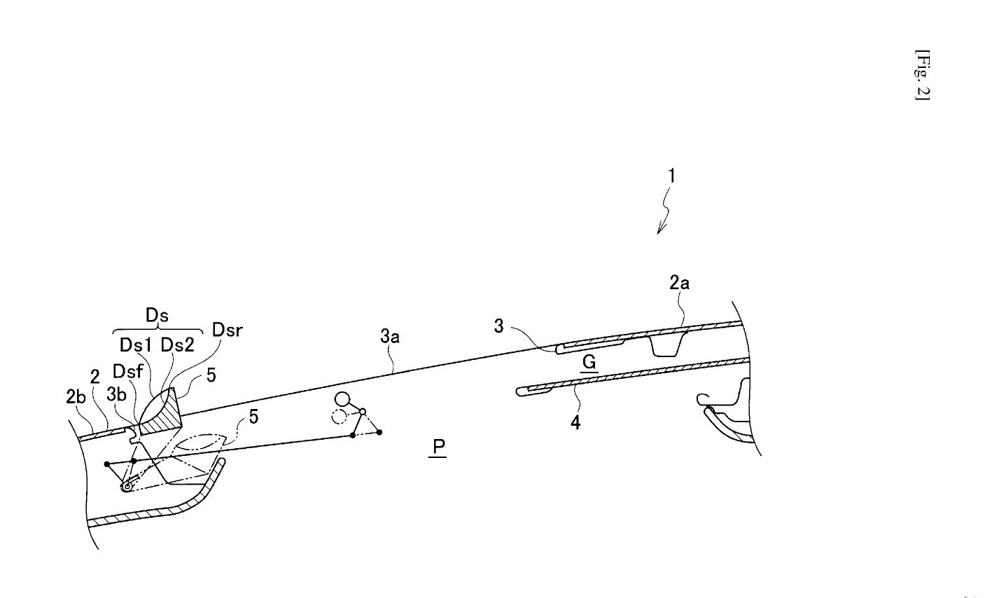

The lid 4 is supported in such a way that it can be guided by a pair of guide rails extending along the left and right edges of the opening 3 and moved in the vehicle front-rear direction between a closed position at which the opening 3 is closed and an open position at which the opening 3 is open. The lid 4 is configured to move between the closed and open positions by being driven by a lid opening-closing device (not shown). At the open position, the lid 4 is housed under a roof panel 2a as shown in FIG. 2.

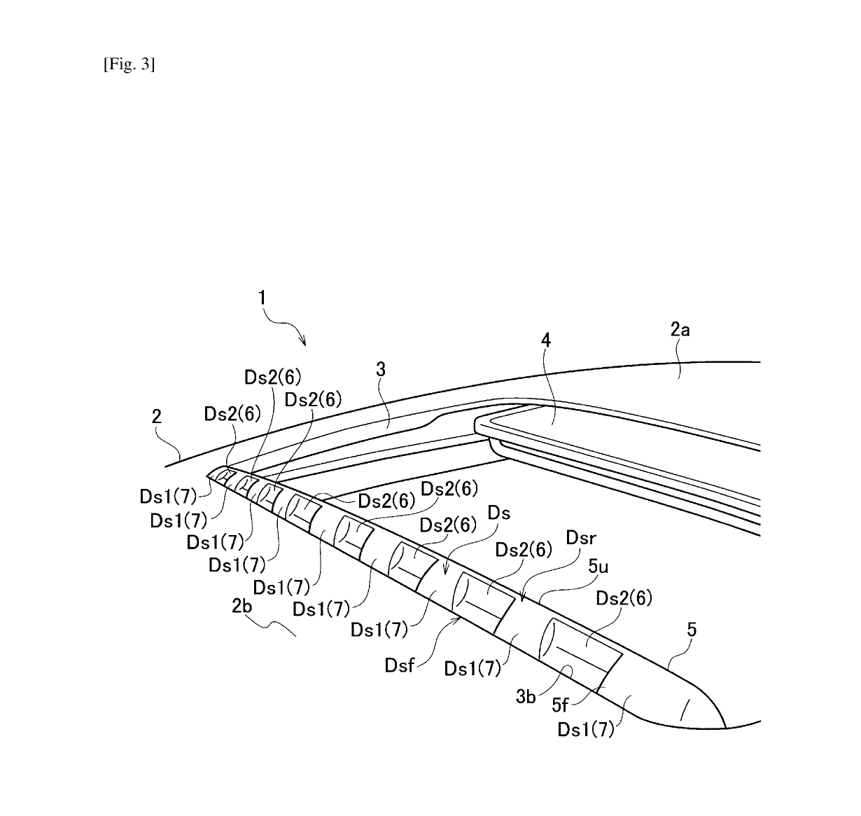

As shown in FIGS. 2 and 3, at the front of the opening 3, there is a deflector blade 5 extending along a front edge 3b of the opening 3. The deflector blade 5 is configured to move up to a raised position (position illustrated with a solid line in FIG. 2) in association with an opening action of the lid 4 (movement from the closed position to the open position). Moreover, the deflector blade 5 is configured to move down to a housed position (position illustrated with a broken line in FIG. 2) in association with a closing action of the lid 4 (movement from the open position to the closed position). These up and down actions of the deflector blade 5 can be realized by means of a lifting device utilizing known electrical and mechanical mechanisms. For example, the up and down actions can be realized by providing a link mechanism through which the deflector blade 5 is pivotally supported on a roof component, and a biasing member such as a coil spring which is configured to constantly bias the deflector blade 5 toward the raised position, the link mechanism being configured such that the deflector blade 5 can be driven to the housed position along the closing action of the lid 4. It is also possible to link a pivotally driving motor to the deflector blade 5 and actuate the motor along the opening and closing actions of the lid 4. Note that the sunroof apparatus is formed of the opening 3, the lid 4, and opening-closing device for the lid 4, the deflector blade 5, the lifting device for the deflector blade 5, etc.

As shown in FIGS. 2 and 3, an upper portion of the deflector blade 5 is designed to project upward and to be located above an upper surface 2b of the roof 2 or a plane defined by the opening 3 (hereinafter, “opening plane 3a”) when the deflector blade 5 is at the raised position. The upper portion of the deflector blade 5 projects from the upper surface 2b of the roof 2 or the opening plane 3a to substantially the same height H over the entire length in the vehicle width direction. The upper end of the upper portion forms an edge portion 5u extending smoothly and continuously in the vehicle width direction and substantially in parallel to the upper surface 2b of the roof 2 or the opening plane 3a. A portion of a front surface 5f of the deflector blade 5 located higher than the upper surface 2b of the roof 2 forms a deflecting surface Ds configured to shift flows of air moving along the upper surface 2b of the roof 2 upward (to form a controlled flows of air moving through a region above and further away from the opening plane 3a).

As shown in FIG. 3, in the deflecting surface Ds of the deflector blade 5, first deflecting surfaces Ds1 configured to shift flows of air moving along the upper surface 2b of the roof 2 upward and second deflecting surfaces Ds2 configured to shift the flows of air further upward than the first deflecting surfaces Ds1 are arranged alternately and are continuous with each other in the extending direction of the deflector blade 5 (a direction along the front edge 3b of the opening 3; the vehicle width direction in this embodiment). That is, one second deflecting surface Ds2 is arranged adjacent to and between each two first deflecting surfaces Ds 1, and one first deflecting surface Ds1 is arranged adjacent to and between each two deflecting surfaces Ds2. In this embodiment, each second deflecting surface Ds2 is a recessed portion 6 having a shape formed to be recessed away from the front, while each first deflecting surface Ds1 is a projected portion 7 having a shape formed to be projected further toward the front than the recessed portion 6.

More specifically, each recessed portion 6 has, in the vicinity of a front edge Dsf of the deflecting surface Ds, a surface that is substantially parallel to the upper surface 2b of the roof 2 in front of the deflector blade 5. On the other hand, the recessed portion 6 has, in the vicinity of a rear edge Dsr of the deflecting surface Ds, a surface that is substantially perpendicular to the upper surface 2b of the roof 2 in front of the deflector blade 5. Moreover, as shown in FIG. 4(a), the recessed portion 6 has, between the vicinity of the front Dsf and the vicinity of the rear edge Dsr, a curved surface being curved such that its inclination angle A₁ to the upper surface 2b of the roof 2 or the opening plane 3a increases gradually from the vicinity of the front edge Dsf to the vicinity of the rear edge Dsr. The radius of curvature of the curved surface and the inclination angle A₁ thereof in the vicinity of the front edge Dsf and in the vicinity of the rear edge Dsr are not particularly limited; appropriate values are preferably set thereto based on wind tunnel tests, numerical fluid analyses, and so on.

Moreover, as shown in FIG. 4(a), when viewed in a cross section perpendicular to the opening plane 3a and parallel to the direction of the main flow of air in front of the deflector blade 5 (a vertical cross section parallel to the vehicle front-rear direction), the surface of the recessed portion 6 forms a curved line which passes through the front and rear edges Dsf and Dsr of the deflecting surface Ds and which is smoothly curved and extended through a region behind and under a straight line m defining an average inclination angle A,, of the deflecting surface Ds. The average inclination angle A,, of the deflecting surface Ds refers to an angle formed between the straight line m, passing through the front and rear edges Dsf and Dsr of the recessed portion 6, and the upper surface 2b of the roof 2 or the opening plane 3a. The size of the average inclination angle A_{avg} is not particularly limited; an appropriate value is preferably set thereto according to the inclination angle of the windshield, the distance from the front edge 2f of the roof 2 to the opening 3, the dimensions of the opening 3, the height H of the deflector blade 5, etc. based on wind tunnel tests, numerical fluid analyses, and so on.

In contrast, each projected portion 7 has, in the vicinity of the front edge Dsf of the deflecting surface Ds, a surface that is substantially perpendicular to the upper surface 2b of the roof 2 in front of the deflector blade 5. On the other hand, the projected portion 7 has, in the vicinity of the rear edge Dsr of the deflecting surface Ds, a surface that is substantially parallel to the upper surface 2b of the roof 2 in front of the deflector blade 5. Moreover, as shown in FIG. 4(b), the projected portion 7 has, between the vicinity of the front Dsf and the vicinity of the rear edge Dsr, a curved surface being curved such that its inclination angle A₂ to the upper surface 2b of the roof 2 or the opening plane 3a decreases gradually from the vicinity of the front edge Dsf to the vicinity of the rear edge Dsr. The radius of curvature of the curved surface and the inclination angle A₂ thereof in the vicinity of the front edge Dsf and in the vicinity of the rear edge Dsr are not particularly limited; appropriate values are preferably set thereto based on wind tunnel tests, numerical fluid analyses, and so on.

Moreover, as shown in FIG. 4(b), when viewed in a cross section perpendicular to the opening plane 3a and parallel to the direction of the main flow of air in front of the deflector blade 5, the surface of the projected portion 7 forms a curved line which passes through the front and rear edges Dsf and Dsr of the deflecting surface Ds and which is smoothly curved and extended through the region in front of and above the straight line m defining the average inclination angle A,, of the deflecting surface Ds.

Note that in a stepped portion formed between each recessed portion 6 and its corresponding projected portion 7 adjacent thereto, there is provided a connecting surface 8 connecting the surface of the recessed portion 6 and the surface of the projected portion 7. In this embodiment, the connecting surface 8 is formed as a flat surface defined by the two curved lines as shown in FIG. 4(a).

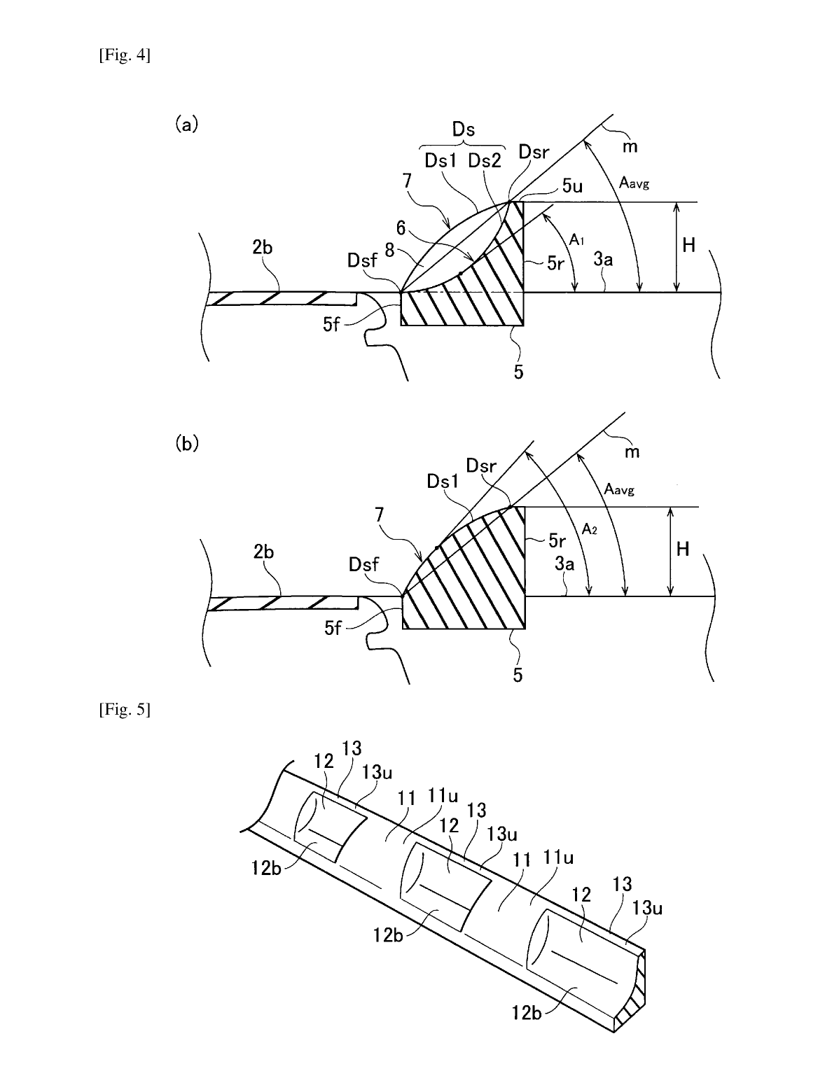

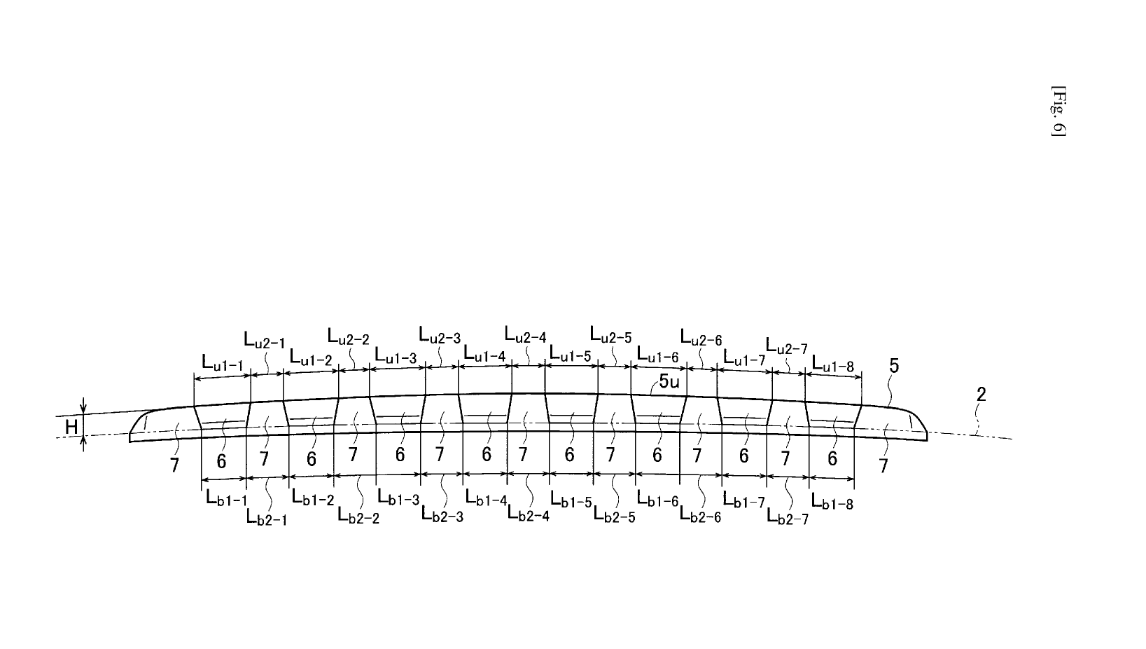

Meanwhile, the shape of the deflector blade 5 according to this embodiment may be described as follows when seen from a different point of view. Specifically, as shown in FIG. 5, the deflector blade 5 includes, in its upper portion: multiple projections 11 formed discontinuously (intermittently) along the front edge 3b of the opening 3 (in the vehicle width direction); multiple recesses 12 each formed between the respective multiple projections 11; and multiple vertical walls 13 each arranged to stand behind the respective recesses 12. The projections 11 are formed to be projected upward to substantially the same height H from the upper surface 2b of the roof 2 or the opening plane 3a. The recesses 12 are each formed such that its bottom surface 12b is lower than the top portions or upper ends 11u of the projections 11 (in this embodiment, the bottom surface 12b is at substantially the same height as the upper surface 2b of the roof 2). The vertical wall 13 is arranged to stand behind each recess 12 and has substantially the same height as each projection 11. Both ends of each vertical wall 13 in the vehicle width direction are joined respectively to the two projections 11 adjacent to the vertical wall 13. Cooperating with the upper ends 11u of the multiple projections 11, upper ends 13u of the multiple vertical walls 13 form the edge portion 5u of the deflector blade 5 which extends smoothly and continuously in the vehicle width direction.

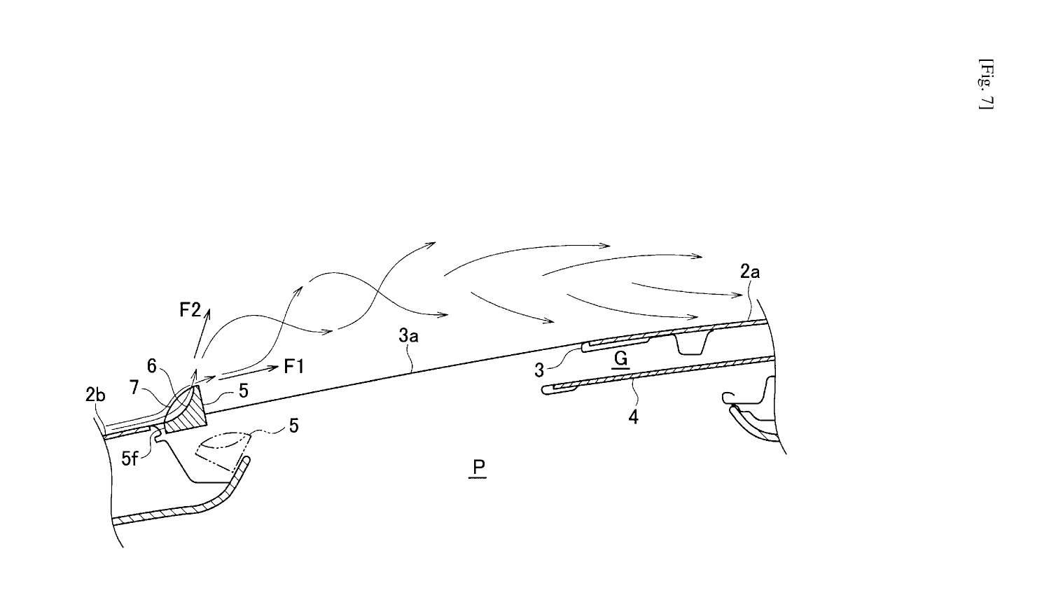

As shown in FIG. 6, the length of each recessed portion 6 (or each recess 12) in the vehicle width direction and the length of each projected portion 7 (or each projection 11) in the vehicle width direction are set to values larger than the height H of the deflector blade 5 (e.g. values about two to five times larger than the height H). Moreover, lengths Lu₁₋₂, Lu₁₋₂ . . . of the upper ends of the recessed portions 6 (or the recesses 12) in the vehicle width direction are set larger than lengths Lb₁₋₁, Lb₁₋₂ . . . of their respective lower ends in the vehicle width direction. Lengths Lu₂₋₁, Lu₂₋₂ . . . of the upper ends of the projected portions 7 (or the projections 11) in the vehicle width direction are set smaller than lengths Lb₂₋₁, Lb₂₋₂ . . . of their respective lower ends in the vehicle width direction. The height H and the lengths Lu₁₋₁, Lu₁₋₂ . . . , Lb₁₋₁, Lb₁₋₂ . . . , Lu₂₋₁, Lu₂₋₂ . . . , and Lb₂₋₁, Lb₂₋₂ . . . are not particularly limited; appropriate values are preferably set thereto based on wind tunnel tests, numerical fluid analyses, and so on.

A back surface 5r (see FIGS. 4(a) and 4(b)) of the deflector blade 5 extends downward from the upper end of the deflector blade 5 and is formed as a flat surface smooth and continuous over the entire length of the deflector blade 5 in the vehicle width direction. Note that the shape of the back surface 5r is not particularly limited; a recess may be provided in each of regions corresponding to the projected portions 7 so that the deflector blade 5 can have a substantially uniform thickness in the front-rear direction over the entire length thereof in the vehicle width direction.

Next, operations and effects of the deflector according to the present invention will be described.

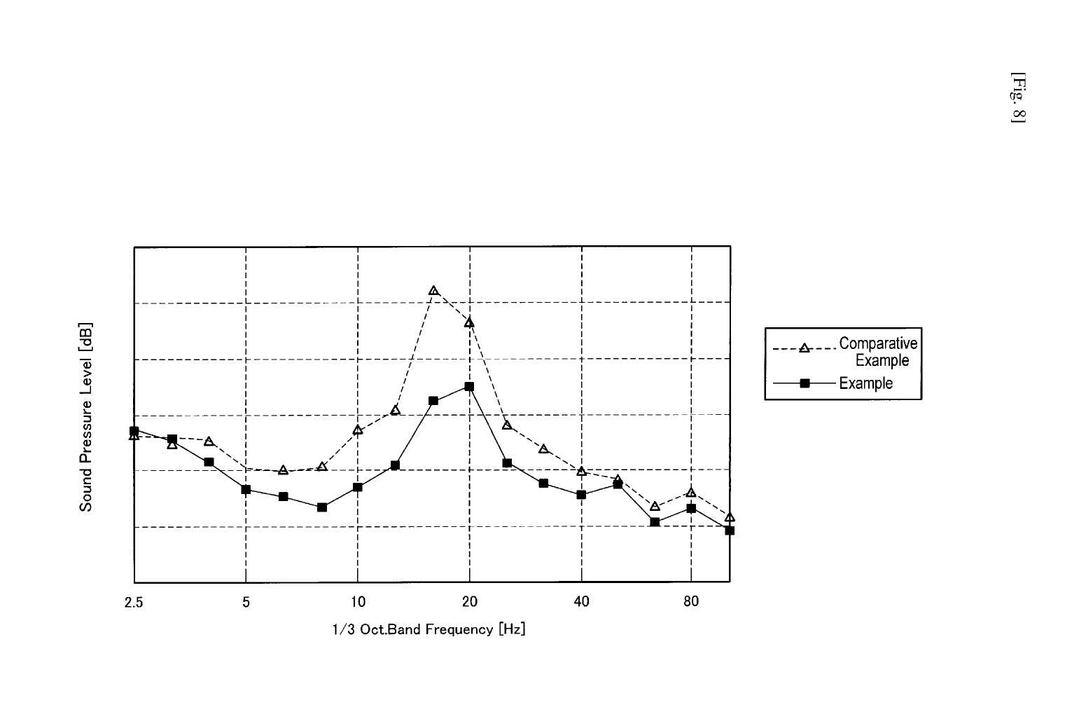

The deflector blade 5 according to this embodiment includes, at its front surface 5f, the recessed portions 6 shaped to be recessed away from the front and the projected portions 7 shaped to be projected further toward the front than the recessed portions 6. Thus, of flows of air moving rearward along the upper surface 2b of the roof 2, the flows colliding with the deflector blade 5 are formed into at least two types of flows leaving the edge portion 5u directed in different directions. Specifically, as shown in FIG. 7, the flows of air colliding with the projected portions 7 flow along and in the shapes of the projected portions 7 projected toward the front. Thus, when the flows separate from the upper edges of the projected portions 7, they are shifted upward and directed toward the rear in a direction substantially parallel to the upper surface 2b of the roof 2 (in the direction of arrow F₁). On the other hand, the flows of air colliding with the recessed portions 6 flow along and in the shapes of the recessed portions 6 recessed away from the front. Thus, when the flows separate from the upper edges of the recessed portions 6, they are shifted upward and directed rearward and upward (further upward than the flows leaving the projected portions 7) (in the direction of arrow F₂). In other words, the upward velocity components of the flows leaving the upper edges of the recessed portions 6 are larger than the upward velocity components of the flows leaving the upper edges of the projected portions 7.

Moreover, in this embodiment, these projected portions 7 and recessed portions 6 are arranged at the front surface 5f of the deflector blade 5 alternately in the extending direction of the deflector blade 5 (in the direction along the front edge 3b of the opening 3; the vehicle width direction in this embodiment). Thus, the flow directed rearward and upward by each recessed portion 6 entrains the flow directed rearward by each projected portion 7 adjacent to the recessed portion 6. As shown in FIG. 7, this facilitates the mixing of the flow leaving the recessed portion 6 and the flow leaving the projected portion 7 and hence reduces the two-dimensionality of vortices shed from the deflector blade 5. Accordingly, the occurrence of the Helmholtz resonance mentioned above is suppressed, thereby reducing the wind throb. Moreover, the flow shifted upward by the projected portion 7 is lifted upward by the flow shifted further upward by the recessed portion 6. Thus, the positions at which the vortices are generated can be raised to positions further away from the opening 3. This reduces the flow of air entering a cabin space P. Accordingly, the occurrence of the Helmholtz resonance is suppressed, thereby reducing the wind throb.

Moreover, in the deflector blade 5 according to this embodiment, the projected portions 7 and the recessed portions 6 are arranged alternately at the front surface 5f of the deflector blade 5, i.e., one recessed portion 6 is arranged adjacent to and between two projected portions 7, and one projected portion 7 is arranged adjacent to and between two recessed portions 6. Thus, flows of air colliding with the deflector blade 5 are all shifted upward by the deflector blade 5 except at both ends of the deflector blade 5 in the vehicle width direction, and the flows of air are prevented from passing through a region lower than the upper edge (edge portion 5u) of the deflector blade 5. This reduces flows of air entering the cabin space P through a rear portion of the opening 3 and also reduces flows of air entering into a gap G between the lid 4 in the open position and the roof panel 2a. Accordingly, it is possible to reduce low-frequency wind noises such as so-called moaning sounds and flapping sounds which are generated due to a flow of air entering into the gap between the lid 4 and the roof panel 2a.

These operations and effects can be explained similarly even when the deflector blade 5 according to this embodiment is seen from a different point of view. Specifically, the deflector blade 5 of this embodiment includes: the multiple projections 11 formed intermittently along the front edge 3b of the opening 3; the recess 12 formed between the multiple projections 11; and the vertical wall 13 standing behind the recess 12. Thus, a flow of air flowing into the recess 12 and directed upward by the vertical wall 13 entrains a flow of air shifted upward and directed rearward by each projection 11 adjacent to the recess 12. Hence, like the above case, the flow shifted upward by the projection 11 is lifted further upward by the flow directed upward through the recess 12, and the mixing of these two flows is facilitated as well. Accordingly, the occurrence of the Helmholtz resonance is suppressed, thereby reducing the wind throb. Moreover, because the deflector blade 5 of this embodiment includes the vertical walls 13 standing behind the recesses 12 formed between the multiple projections 11, flows of air colliding with the deflector blade 5 cannot pass through a region lower than the upper edge of the deflector blade 5. This reduces flows of air entering the cabin space P through the opening 3 and thereby also reduces flows of air entering into the gap G between the lid 4 in the open position and the roof panel 2a. Accordingly, it is possible to reduce also low-frequency wind noises generated due to a flow of air entering into the gap G.

Further, in the deflector blade 5 according to this embodiment, the positions at which vortices are shed from and generated past the deflector blade 5 can be effectively raised to higher positions than otherwise as described above. Thus, the height H of the deflector blade 5 can be reduced accordingly. This reduces high-frequency wind noises such as so-called whizzing sounds which are generated due to a flow of air colliding with the deflector blade 5 while the vehicle 1 travels at high speed.

Moreover, in the deflector blade 5 according to this embodiment, the surface of each recessed portion 6 is formed as a curved surface being curved such that its inclination angle Aₗ to the upper surface 2b of the roof 2 increases gradually from the front edge side to the rear edge side. Thus, a flow of air colliding with the recessed portion 6 flows smoothly along the curved surface. Accordingly, a noise generated due to turbulence in the airflow is reduced further.

Further, in the deflector blade 5 according to this embodiment, the surface of each projected portion 7 is formed as a curved surface being curved such that its inclination angle A₂ to the upper surface 2b of the roof 2 decreases gradually from the front edge side to the rear edge side. Thus, a flow of air colliding with the projected portion 7 flows smoothly along the curved surface. Accordingly, the noise generated due to turbulence in the airflow is reduced even further.

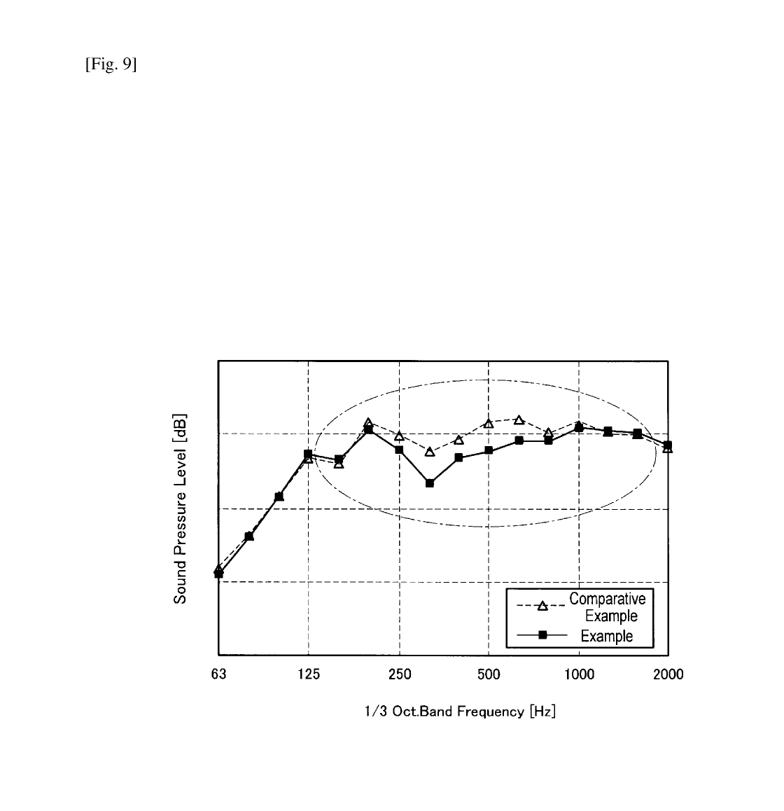

To evaluate the effects of the deflector according to the present invention, aerodynamic noises generated during travel were compared between a vehicle employing the deflector blade 5 according to the present invention and a vehicle employing a deflector blade according to a comparative example. Specifically, a vehicle equipped with the deflector blade to be tested was placed in a wind tunnel with its sunroof opening 3 being open. Then, air was blown against the deflector blade from the front of the vehicle, and the sound pressure level at the headrest of a rear seat in the cabin was measured. FIGS. 8 and 9 show the measurement results.

In each of FIGS. 8 and 9, the horizontal axis shows one-third octave band frequencies [Hz] while the vertical axis shows sound pressure levels [dB]. Moreover, “EXAMPLE” shows the measurement results of the vehicle employing the deflector blade 5 according to the present invention, while “COMPARATIVE EXAMPLE” shows the measurement results of the vehicle employing the defector blade according to the comparative example. The deflector blade according to the comparative example is equivalent to the deflector blade 5 according to the present invention with the recessed portions 6 being removed. Note that both examples are the same in the size and shape of the sunroof opening, the height of the projection of the deflector blade from the upper surface of the roof, the length of the deflector blade in the vehicle width direction, the average inclination angle, and the dimensions of each projected portion in a front view.

FIG. 8 shows the results of measurement in which the wind speed inside the wind tunnel is set to a wind speed equivalent to travelling at 45 [km/h]. The speed of 45 [km/h] belongs to a speed range within which a wind throb is likely to be generated. FIG. 8 shows that the sound pressure level is significantly decreased over the entire frequency band in the deflector blade 5 according to the present invention, as compared to the deflector blade according to the comparative example. FIG. 8 also shows that the sound pressure level is decreased by approximately 10 dB particularly in a frequency band around 16 Hz. Accordingly, the deflector blade 5 according to the present invention is confirmed to be capable of significantly reducing a wind throb as compared to the deflector blade according to the comparative example.

FIG. 9 shows the results of measurement in which the wind speed inside the wind tunnel is set to a wind speed equivalent to travelling at 120 [km/h]. The speed of 120 [km/h] belongs to a speed range within which the above-described wind noises are likely to be generated. FIG. 9 shows that the sound pressure level is significantly decreased over a frequency band from 125 to 1500 [Hz] in the deflector blade 5 according to the present invention, as compared to the deflector blade according to the comparative example. Accordingly, the deflector blade 5 according to the present invention is confirmed to be also capable of significantly reducing the wind noises during high-speed travel, as compared to the deflector blade according to the comparative example.

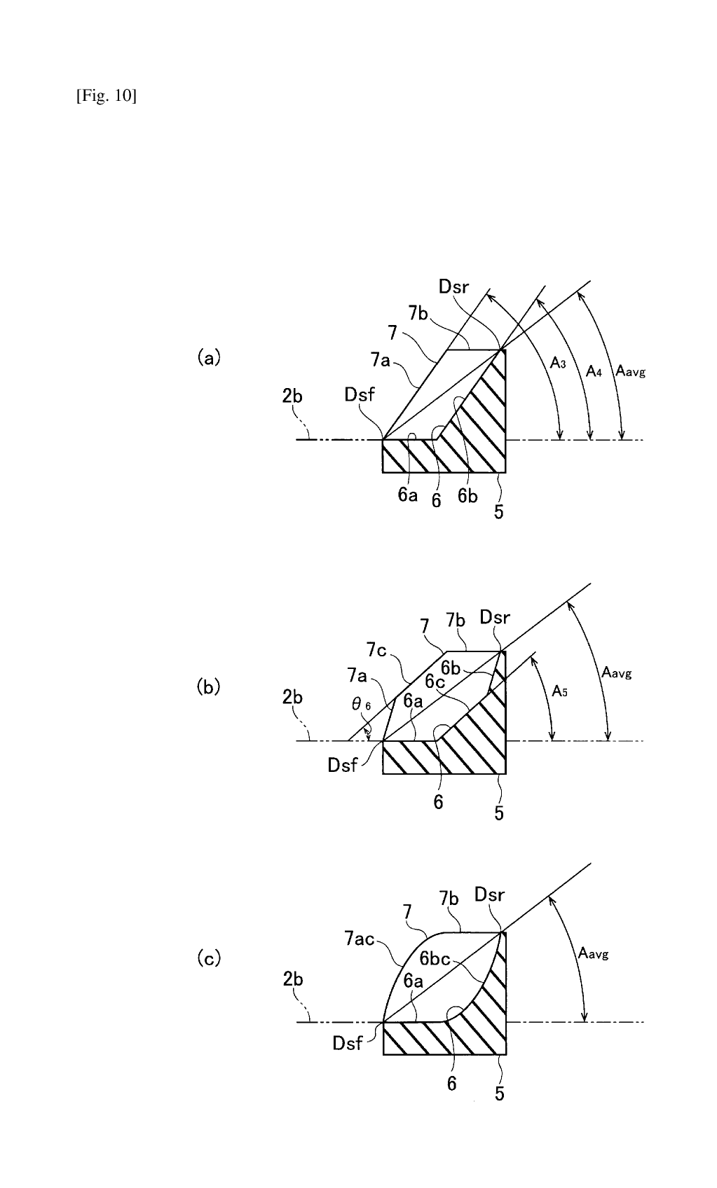

While an embodiment of the present invention has been described hereinabove, this embodiment is merely illustration described to facilitate understanding of the present invention, and the present invention is not limited to the embodiment. The technical scope of the present invention is not limited to the specific technical matters disclosed in the above embodiment but encompasses various modifications, changes, alternative techniques, and the like that can be easily conceived therefrom. For example, although the surface of each projected portion 7 is formed as a smoothly curved surface projected toward the front, and the surface of each recessed portion 6 is formed as a smoothly curved surface recessed away from the front, the surfaces of the projected portion 7 and the recessed portion 6 are not limited to these shapes. FIGS. 10(a) to 10(c) show cross sections of modifications according to the present invention, which are perpendicular to the opening plane 3a and parallel to the direction of the main flow of air in front of the deflector blade 5.

As shown in FIG. 10(a), the surface of each projected portion 7 may be formed of: a flat inclined front surface 7a extending upwardly rearward from the front edge Dsf of the deflecting surface Ds at an inclination angle A₃ which is larger than the average inclination angle A_{avg}; and a flat horizontal upper surface 7b extending rearward from the upper end of the inclined front surface 7a. Moreover, the surface of each recessed portion 6 may be formed of: a flat horizontal lower surface 6a extending rearward from the front edge Dsf of the deflecting surface Ds; and a flat inclined rear surface 6b extending upwardly rearward from the rear end of the horizontal lower surface 6a at an inclination angle A₄ which is larger than the average inclination angle A_{avg}. With this configuration, the degree of turbulence on the downstream side of the deflector blade can be increased, in addition to effects similar to the above embodiment. Accordingly, it is possible to further facilitate the mixing of the flow shifted upward by the recessed portion 6 and the flow shifted upward by the projected portion 7.

While FIG. 10(a) shows an example where the surfaces of the projected portion 7 and the recessed portion 6 are each formed of two flat surfaces, the number of flat surfaces forming each surface may be three or more as shown in FIG. 10(b). In this case, a flat inclined middle surface 7c inclined at an inclination angle A₅ which is substantially equal to the average inclination angle A_{avg} is provided as a connecting surface connecting the inclined front surface 7a and the horizontal upper surface 7b in FIG. 10(a) and located therebetween. Similarly, for the recessed portion 6, a flat inclined middle surface 6c inclined at an inclination angle A₆ which is substantially equal to the average inclination angle A_{avg} is provided as a connecting surface connecting the horizontal lower surface 6a and the inclined rear surface 6b in FIG. 10(a) and located therebetween. With this configuration, the degree of turbulence on the downstream side of the deflector blade can be adjusted.

Alternatively, some of the inclined front surface 7a, the horizontal upper surface 7b, the inclined rear surface 6b, the horizontal lower surface 6a, and the inclined middle surfaces 6c and 7c in FIGS. 10(a) and 10(b) may be formed as a smoothly curved surface(s). For example, as shown in FIG. 10(c), the inclined front surface 7a in FIG. 10(a) may be formed as a smoothly curved surface 7ac projected toward the front, and the inclined rear surface 6b in FIG. 10(a) may be formed as a smoothly curved surface 6bc recessed away from the front. With this configuration, the following effect can be achieved in addition effects similar to the above embodiment. Specifically, in this modification, a flow of air moving along the surface of each projected portion 7 becomes a flow parallel to the horizontal upper surface 7b after moving along the curved surface, and then gets mixed with a flow of air moving upward along the curved surface of each adjacent recessed portion 6. In this way, it is possible to surely increase the degree of the mixing of the flow shifted upward by the recessed portion 6 and the flow shifted upward by the projected portion 7. Thus, the two-dimensionality of vortices shed from the deflector blade 5 are further reduced. Accordingly, the occurrence of the Helmholtz resonance can be surely suppressed, thereby reducing the wind throb.

The subject application claims the priority based on Indian Patent Application No. 1233/KOL/2013 filed on Oct. 30, 2013, and the entire content thereof is incorporated herein by reference.

### INDUSTRIAL APPLICABILITY

A deflector of the present invention and a sunroof apparatus including the deflector of the present invention can be applied to a vehicle.

### REFERENCE SIGNS LIST

1 vehicle
2 roof
2b upper surface
3 sunroof opening (opening)
3b front edge
5 deflector blade (deflector)
5f front surface
6 recessed portion
7 projected portion
11 projection
12 recess
13 vertical wall
Dsf front edge
Dsr rear edge
A₁, A₂ inclination angle

1. A deflector extending along a front edge of an opening provided in a roof of a vehicle, comprising:
a plurality of recessed portions each being formed to be recessed away from a front; and
a plurality of projected portions each being formed to be projected further toward the front than the recessed portions,
wherein the recessed portions and the projected portions are arranged at a front surface of the deflector alternately in an extending direction of the deflector.

2. The deflector according to claim 1, wherein each of the recessed portions has a curved surface being curved such that an inclination angle of the curved surface to an upper surface of the roof increases gradually from a front edge side to a rear edge side.

3. The deflector according to claim 1, wherein each of the projected portions has a curved surface being curved such that an inclination angle of the curved surface to an upper surface of the roof decreases gradually from a front edge side to a rear edge side.

4. A deflector extending along a front edge of an opening provided in a roof of a vehicle, comprising:
a plurality of projections formed intermittently along the front edge of the opening, each of the projections being formed to be projected upward;
a recess formed between the plurality of projections; and
a vertical wall arranged to stand behind the recess.

5. A sunroof apparatus comprising the deflector according claim 1.

6. A sunroof apparatus comprising the deflector according claim 2.

7. A sunroof apparatus comprising the deflector according claim 3.

8. A sunroof apparatus comprising the deflector according claim 4.

9. The deflector according to claim 2, wherein each of the projected portions has a curved surface being curved such that an inclination angle of the curved surface to an upper surface of the roof decreases gradually from a front edge side to a rear edge side.

10. A sunroof apparatus comprising the deflector according claim 9.
